(19) United States
(12) Patent Application Publication
(10) Pub. No.: US 2020/0137788 A1
(43) Pub. Date: Apr. 30, 2020

(54) METHOD AND APPARATUS FOR COMMUNICATION IN LTE SYSTEM ON UNLICENSED SPECTRUM

(71) Applicant: Intel IP Corporation, Santa Clara, CA (US)

(72) Inventors: Wenting Chang, Beijing (CN); Huaning Niu, San Jose, CA (US); Salvatore Talarico, Sunnyvale, CA (US); Jinnian Zhang, Beijing (CN)

(21) Appl. No.: 16/483,561

(22) PCT Filed: Jun. 12, 2018
(86) PCT No.: PCT/CN2018/090822

§ 371 Date: Aug. 5, 2019

(30) Foreign Application Priority Data
Jun. 13, 2017 (CN) PCT/CN2017/088059
Jun. 13, 2017 (CN) PCT/CN2017/088072

(51) Int. Cl. H04W 72/14; H04W 16/14; H04W 74/08; H04L 5/00

(52) U.S. Cl. CPC H04W 72/14; H04W 16/14; H04L 5/0044; H04L 5/0007; H04L 5/005; H04W 74/0808

(57) ABSTRACT

Provided herein are method and apparatus for communication in LTE system on unlicensed spectrum. An apparatus for a user equipment (UE) may include: circuitry configured to: detect a presence detection reference signal for a channel having a dwell period on an unlicensed spectrum; and determine a location of a starting subframe for a physical downlink control channel (PDCCH) in the dwell period based on detection of the presence detection reference signal; and a memory to store the location of the starting subframe. In some embodiments of the present disclosure, the dwell period is fixed. In some embodiments, the dwell period comprises a fixed downlink dwell period and a fixed uplink dwell period.

### CROSS REFERENCES TO RELATED APPLICATIONS

This application claims priority to International Application No. PCT/CN2017/088059 filed on Jun. 13, 2017, entitled “FRAME STRUCTURE AND CONFIGURATION FOR EMTC_U” and International Application No. PCT/CN2017/088072 filed on Jun. 13, 2017, entitled “MF RAN1 PDCCH AND PDSCH DESIGN FOR EMTC_U SYSTEM”, both of which are incorporated by reference herein in their entirety for all purposes.

### TECHNICAL FIELD

Embodiments of the present disclosure generally relate to apparatus and method for wireless communications, and in particular to communication in Long-Term-Evolution (LTE) system on unlicensed spectrum.

### BACKGROUND ART

The explosive wireless traffic growth leads to an urgent need of rate improvement. With mature physical layer techniques, further improvement in the spectral efficiency will be marginal. On the other hand, the scarcity of licensed spectrum in low frequency band results in a deficit in data rate boost. Thus, there are emerging interests in the operation of LTE systems on unlicensed spectrum.

### SUMMARY

An embodiment of the disclosure provides an apparatus for a user equipment (UE), the apparatus comprising circuitry configured to: detect a presence detection reference signal for a channel having a dwell period on an unlicensed spectrum; and determine a location of a starting subframe for a physical downlink control channel (PDCCH) in the dwell period based on detection of the presence detection reference signal.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 shows an architecture of a system of a network in accordance with some embodiments of the disclosure.

FIG. 2 shows an illustrative example of frame structure based on LBT based mechanism in accordance with some embodiments of the disclosure.

FIG. 3 shows an illustrative example of frame structure based on LBT based mechanism in accordance with some embodiments of the disclosure.

FIG. 4 shows an illustrative example of frame structure based on non-LBT based mechanism in accordance with some embodiments of the disclosure.

FIG. 5 is a flow chart showing operations on unlicensed spectrum based on LBT-based mechanism in accordance with some embodiments of the disclosure.

FIG. 6 shows an example scheduling of PDCCH for PDSCH and PUSCH in accordance with some embodiments of the disclosure.

FIG. 7a shows an example of a non-adaptive frequency hopping in accordance with some embodiments of the disclosure.

FIG. 7b shows another example of a non-adaptive frequency hopping in accordance with some embodiments of the disclosure.

FIG. 8 illustrates example components of a device in accordance with some embodiments of the disclosure.

FIG. 9 illustrates example interfaces of baseband circuitry in accordance with some embodiments.

FIG. 10 is a block diagram illustrating components, according to some example embodiments, able to read instructions from a machine-readable or computer-readable medium and perform any one or more of the methodologies discussed herein.

### DETAILED DESCRIPTION OF EMBODIMENTS

Various aspects of the illustrative embodiments will be described using terms commonly employed by those skilled in the art to convey the substance of their work to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in an embodiment” is used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Internet of Things (IoT) is a significantly important technology, which may enable connection between tons of devices. IoT may support wide applications in various scenarios, including but not limited to, smart cities, smart environment, smart agriculture, and smart health systems.

The third Generation Partnership Project (3GPP) has standardized two designs to support IoT services: one is enhanced Machine Type Communication (eMTC); and another one is NarrowBand IoT (NB-IoT). As eMTC and NB-IoT devices may be deployed in huge numbers, it is important to lower cost of these devices for implementation of IoT. Also, low power consumption is desirable to extend life time of batteries in the devices. In addition, there are substantial use cases of devices that may operate deep inside buildings, which would require coverage enhancement in comparison to the defined LTE cell coverage footprint. In summary, eMTC and NB-IoT techniques are designed to ensure low cost, low power consumption, and enhanced coverage.

Explosive wireless traffic growth leads to an urgent need of unlicensed spectrum resource, e.g., 2.4 GHz band, to improve capacity of a wireless communication system. Potential LTE operation on unlicensed spectrum includes, but is not limited to, the LTE operation on the unlicensed spectrum via dual connectivity (DC)—known as DC-based LAA, and the standalone LTE system on the unlicensed spectrum, where LTE-based technology solely operates on unlicensed spectrum without requiring an “anchor” in licensed spectrum, known as MuLTEfire™ (or “MF”). MuLTEfire combines the performance benefits of LTE technology with the simplicity of WiFi-like deployments, is envisioned as a significantly important technology component to meet the ever-increasing wireless traffic.

For global availability, the designs should abide by regulations in different regions, e.g. the regulations given by Federal Communication Commission (FCC) in the US and the regulations given by European Telecommunication Standards Institute (ETSI) in Europe. Based on these regulations, frequency hopping is more appropriate than other forms of modulations, due to more relaxed power spectrum density (PSD) limitation and co-existence with other unlicensed band technology such as Bluetooth and WiFi.

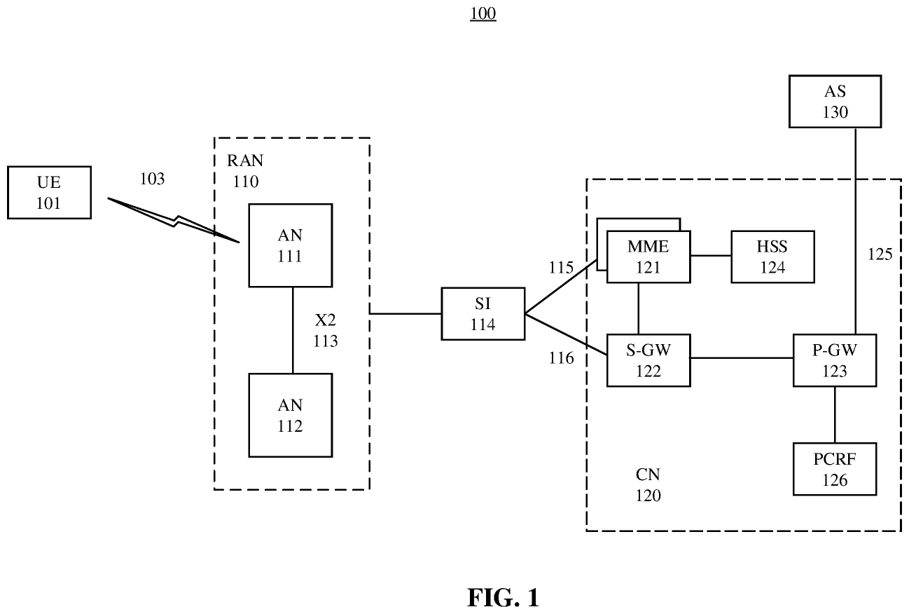

FIG. 1 illustrates an architecture of a system 100 of a network in accordance with some embodiments. The system 100 is shown to include a user equipment (UE) 101. The UE 101 is illustrated as a smartphone (e.g., a handheld touchscreen mobile computing device connectable to one or more cellular networks). However, it may also include any mobile or non-mobile computing device, such as a personal data assistant (PDA), a tablet, a pager, a laptop computer, a desktop computer, a wireless handset, or any computing device including a wireless communications interface.

In some embodiments, the UE 101 may be an Internet of Things (IoT) UE, which may comprise a network access layer designed for low-power IoT applications utilizing short-lived UE connections. An IoT UE may utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, the UE 101 may operate using unlicensed spectrum, e.g. via MuLTEfire. For instance, UE 101 may include radio circuitry capable of receiving a first carrier using licensed spectrum and a second carrier using unlicensed spectrum simultaneously or alternately. Further, although FIG. 1 show one UE 101 for simplicity, in practice there may be one or more UEs operate in system 100. The UEs additional to UE 101 may be legacy UEs that can operate only on licensed spectrum, or UEs that are capable of utilizing the unlicensed spectrum.

The UE 101 may be configured to connect, e.g., communicatively couple, with a radio access network (RAN) 110, which may be, for example, an Evolved Universal Mobile Telecommunications System (UMTS) Terrestrial Radio Access Network (E-UTRAN), a NextGen RAN (NG RAN), or some other type of RAN. The UE 101 may utilize a connection 103 to enable communicative coupling with the RAN 110. The UE 101 may operate in consistent with cellular communications protocols, such as a Global System for Mobile Communications (GSM) protocol, a Code-Division Multiple Access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

The RAN 110 may include one or more access nodes (ANs), e.g., AN 111 that enables the connection 103 with the UE 101. These access nodes may be referred to as base stations (BSs), NodeBs, evolved NodeBs (eNBs), next Generation NodeBs (gNBs), and so forth, and may include ground stations (e.g., terrestrial access points) or satellite stations providing coverage within a geographic area (e.g., a cell). As shown in FIG. 1, for example, the RAN 110 includes AN 111 and AN 112. The AN 111 and AN 112 may communicate with one another via an X2 interface 113. The AN 111 and AN 112 may be macro ANs which may provide lager coverage. Alternatively, they may be femtocell ANs or picocell ANs, which may provide smaller coverage areas, smaller user capacity, or higher bandwidth compared to a macro AN. For example, one or both of the AN 111 and AN 112 may be a low power (LP) AN. In an embodiment, the AN 111 and AN 112 may be the same type of AN. In another embodiment, they are different types of ANs.

In some embodiments, the AN 111 may operate using unlicensed spectrum, e.g. via MuLTEfire. For instance, the AN 111 may include radio circuitry capable of transmitting and receiving both the first carrier using licensed spectrum and the second carrier using unlicensed spectrum.

The AN 111 may terminate the air interface protocol and may be the first point of contact for the UE 101. In some embodiments, any of the ANs 111 and 112 may fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UE 101 may be configured to communicate using Orthogonal Frequency-Division Multiplexing (OFDM) communication signals with the AN 111 or with other UEs over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and Proximity-Based Service (ProSe) or sidelink communications), although the scope of the embodiments is not limited in this respect. The OFDM signals can include a plurality of orthogonal subcarriers.

In some embodiments, a downlink resource grid may be used for downlink transmissions from the AN 111 to the UE 101, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 101. The physical downlink control channel (PDCCH) may carry information about the transport format and resource allocations related to the PDSCH channel, among other things. It may also inform the UE 101 about the transport format, resource allocation, and HARQ (Hybrid Automatic Repeat Request) information related to the uplink shared channel. Typically, downlink scheduling (assigning control and shared channel resource blocks to the UE 101 within a cell) may be performed at the AN 111 based on channel quality information fed back from the UE 101. The downlink resource assignment information may be sent on the PDCCH used for (e.g., assigned to) the UE 101.

In the context of the present application, the PDCCH may include eMTC PDCCH (eMPDCCH) used in eMTC technique and NB-IoT PDCCH (NPDCCH) used in NB-IoT technique.

The RAN 110 is shown to be communicatively coupled to a core network (CN) 120 via an Si interface 114. In some embodiments, the CN 120 may be an evolved packet core (EPC) network, a NextGen Packet Core (NPC) network, or some other type of CN. In an embodiment, the Si interface 114 is split into two parts: the S1-mobility management entity (MME) interface 115, which is a signaling interface between the ANs 111 and 112 and MMEs 121; and the S1-U interface 116, which carries traffic data between the ANs 111 and 112 and a serving gateway (S-GW) 122.

In an embodiment, the CN 120 may comprise the MMEs 121, the S-GW 122, a Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-AN handovers and also may provide an anchor for inter-3GPP mobility. Other responsibilities may include lawful intercept, charging, and some policy enforcement.

The P-GW 123 may terminate a SGi interface toward a PDN. The P-GW 123 may route data packets between the CN 120 and external networks such as a network including an application server (AS) 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In an embodiment, the P-GW 123 is communicatively coupled to an application server 130 via an IP communications interface. The application server 130 may also be configured to support one or more communication services (e.g., Voice-over-Internet Protocol (VoIP) sessions, PTT sessions, group communication sessions, social networking services, etc.) for the UE 101 via the CN 120.

The P-GW 123 may further be responsible for policy enforcement and charging data collection. Policy and Charging Rules Function (PCRF) 126 is a policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with an appropriate traffic flow template (TFT) and QoS class of identifier (QCI), which commences the QoS and charging as specified by the application server 130.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of system 100 may perform one or more functions described as being performed by another one or more of the devices of system 100. Furthermore, while “direct” connections are shown in FIG. 1, these connections should be interpreted as logical communication pathways, and in practice, one or more intervening devices (e.g., routers, gateways, modems, switches, hubs, etc.) may be present.

The AN 111 and the UE 101 will be used to describe the following embodiments. In these embodiments, the AN 111 and the UE 101 may operate as an unlicensed AN and an unlicensed UE respectively, which may operate on unlicensed spectrum. To enable the co-existence of the AN 111 and other unlicensed ANs that operate on the same unlicensed spectrum as AN 111, e.g., 2.4 GHz, different mechanisms are proposed.

In some embodiments, a listen-before-talk (LBT) based mechanism may be used in which the AN 111 determines whether a particular frequency channel is already occupied before using it. That is, with LBT, data may only be transmitted when a channel is sensed to be idle. The LBT based mechanism may include Clear Channel Assessment (CCA) and extended CCA (eCCA).

In other embodiments, a non-LBT based mechanism may be used. For instance, a “single shot” mechanism may be used in which only one CCA may be performed or the UE may simply start transmissions, when the UE is scheduled for the transmissions by the AN and the AN has reserved resources for the UE.

In the ETSI, there are different rules for LBT based mechanism and non-LBT based mechanism. For the LBT based mechanism, the time period for CCA and eCCA may be up to maximum between 0.2%* Channel Occupancy Time (COT) and 20 us. If a channel is detected successfully within the time period, the maximum COT (MCOT) may be 60 ms, followed by an idle period of 5%*COT.

For the non-LBT based mechanism, the MCOT may be 40 ms, followed by an idle period of 5%*COT. But if a channel is marked as unavailable, the AN and/or the UE have to waited for 1 second before using the channel again.

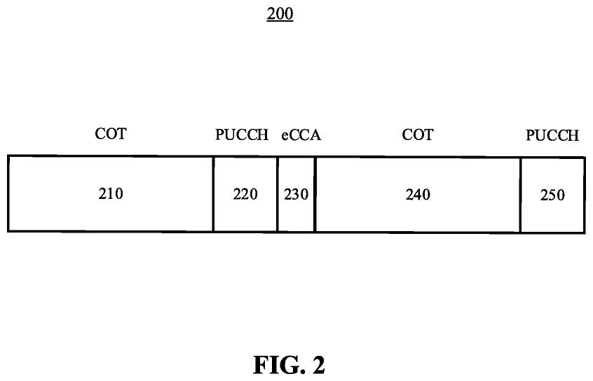

FIG. 2 shows an illustrative example of frame structure based on LBT based mechanism in accordance with some embodiments of the disclosure.

There may be one or more transmissions in certain frequency resource. As shown in FIG. 2, once a first transmission 210 is completed, an idle period (e.g., 5%*MCOT) 220 may exist prior to a second transmission 240. In some embodiments, an uplink transmission may be performed during the idle period 220. As shown in FIG. 2, physical uplink control channel (PUCCH) may be transmitted during the idle period 220 to improve efficiency of resource. In other words, transmission of PUCCH doesn't occupy the MCOT.

In some embodiments based on the LBT based mechanism, CCA and/or eCCA 230 may be performed before the second transmission 240, as shown in FIG. 2. In these embodiments, MCOT may be 60 ms, and the idle period may be 3 ms.

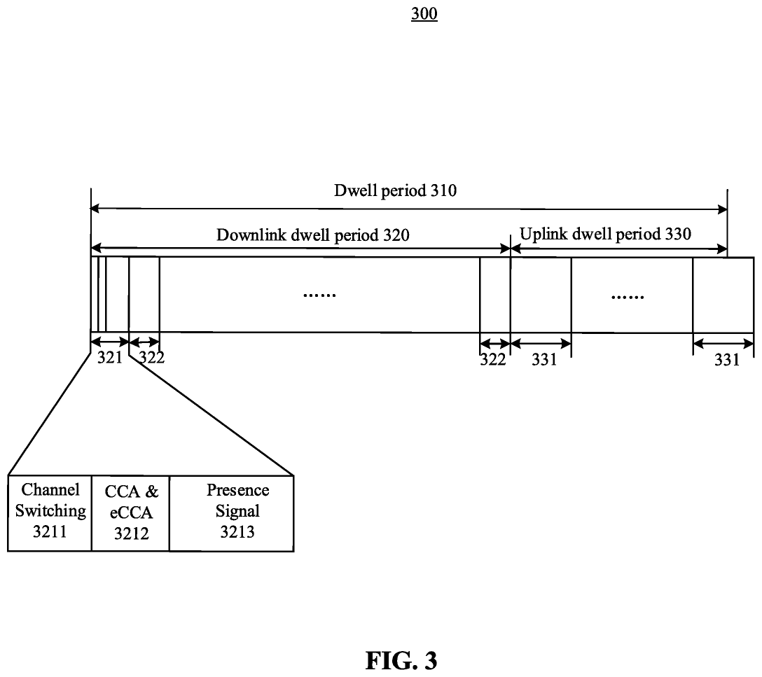

FIG. 3 shows an illustrative example of frame structure based on LBT based mechanism in accordance with some embodiments of the disclosure.

As shown in FIG. 3, a dwell period 310 of a channel may include a downlink dwell period 320 and an uplink dwell period 330. The downlink dwell period 320 may include a plurality of downlink subframes and the uplink dwell period 330 may include a plurality of uplink subframes.

In some embodiments, the downlink dwell period 320 may include a non-data period 321 and a plurality of valid downlink subframes 322. The non-data period 321 include a plurality of downlink subframes that are used for non-data procedure. The plurality of valid downlink subframes 322 are used for transmission of data including control information and traffic data.

In some embodiments, the non-data period 321 may include a channel switching period 3211, a CCA & eCCA period 3212 and a presence signal period 3213. The channel switching period 3211 may be used to perform frequency hopping among different channels. The CCA & eCCA period 3212 may be used to perform CCA and/or eCCA to detect whether the channel is idle. The presence signal period 3213 may be used to transmit a presence detection reference signal (PDRS) once the channel is determined to be idle.

In some embodiments, the channel switching period 3211 may be reserved at the burst start of the dwell period 310 of a first channel to which the AN 111 and/or the UE 101 switches, as shown in FIG. 3. In particularly, the channel switching period 3211 may include the first several OFDM symbols (e.g., the first two OFDM symbols) of the first subframe of the dwell period 310.

In some embodiments, the channel switching period 3211 may be reserved at the burst end of a dwell period of a second channel from which the AN 111 and/or the UE 101 switches. In particularly, the channel switching period 3211 may include last several OFDM symbols (e.g., the last two OFDM symbols) of the last subframe of the dwell period of the second channel If the bust end of the second channel is included in an uplink subframe, the channel switching period 3211 may be reserved by timing advance.

In some embodiments, a dwell period of a channel may be larger to contain a time period to reserve for channel switching.

In some embodiments, among the plurality of valid downlink subframes 322, the first downlink subframe and the last downlink subframe are used to transmit downlink transmissions, and other downlink subframes may be used to transmit either downlink transmissions or uplink transmissions.

In some embodiments, the uplink dwell period 330 may include a plurality of uplink subframes (not shown), which are used to transmit uplink transmissions and non-data procedure. In some embodiments, a predetermined number of uplink subframes may form an uplink transmission unit 331, as shown in FIG. 3. For example, each uplink transmission unit 331 may include 5 contiguous uplink subframes, that is, each uplink transmission unit 331 may have 5 ms in time domain. In an embodiment, the number of the uplink subframes contained in each uplink transmission unit 331 may be configured by the AN 111. In another embodiment, it is predefined.

In some embodiments, a predetermined number of downlink subframes may also form a downlink transmission unit (not shown).

In some embodiments, the dwell period 310 is fixed. For example, the dwell period may be 75 ms. In some embodiments, both of the downlink dwell period 320 and the uplink dwell period 330 is fixed. For example, the downlink dwell period 320 may be 60 ms, and the uplink dwell period 330 may be 15 ms.

In the LBT based mechanism, the location of the starting subframe for valid downlink transmissions is floating, as the AN 111 may perform CCA and/or eCCA multiple times to determine whether the channel is available. In other words, location of the first downlink subframe 322 is not fixed due to LBT. For example, in the case that the dwell period 310 is fixed, e.g., 75 ms, and the uplink dwell period 330 is fixed, e.g., 15 ms, the time period for the downlink transmissions in the plurality of downlink subframes 322 is flexible due to the non-data period 321. For example, if the non-data period 321 is 3 ms, the time period for the downlink transmissions is 57 ms.

In some embodiments, the dwell period 310 is fixed, the uplink dwell period 330 is flexible, and the downlink dwell period 320 is flexible. In this case, the time period for the downlink transmissions is fixed.

In embodiments where the time period for the valid downlink transmissions is fixed and the uplink dwell period 330 is flexible, the end or start of the uplink dwell period 330 may be punctured to reserve time for flexible starting. In embodiments where the time period for the valid downlink transmissions is flexible and the uplink dwell period 330 is fixed, the end or start of the time period for the valid downlink transmissions may be punctured to reserve time for flexible starting.

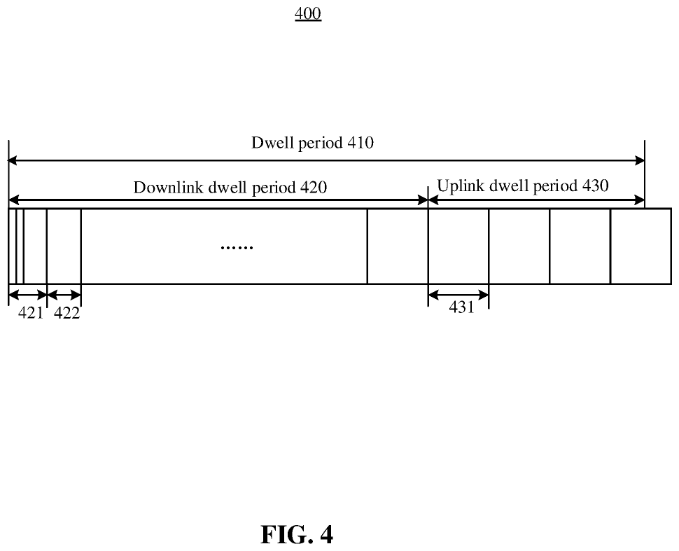

FIG. 4 shows an illustrative example of frame structure based on non-LBT based mechanism in accordance with some embodiments of the disclosure. As shown in FIG. 4, a dwell period 410 of a channel may include a downlink dwell period 420 and an uplink dwell period 430. In some embodiments, the downlink dwell period 420 may include a non-data period 421 and a plurality of valid downlink subframes 422. The uplink dwell period 430 may include a plurality of uplink subframes, which may form a number of uplink transmission unit 431.

The difference compared with FIG. 3 is that the downlink dwell period 420 may be only 40 ms based on rules of the ETSI. In addition, during the non-data period 421, procedures corresponding to a non-LBT based mechanism may be performed, which are omitted herein for simplicity.

In some embodiments, the downlink dwell period 320 and 420 may include multiple contiguous downlink subframes. Alternatively, the downlink dwell period 320 and 420 may include non-contiguous downlink subframes, e.g., 5 downlink subframes that are concatenated with 5 uplink subframes.

In some embodiments, the valid uplink and downlink subframes that are used for data transmissions may be configured by the AN 111. In one embodiment, two separate subframe bitmaps may be configured for downlink subframes and uplink subframes. In another embodiment, a joint subframe bitmap may be configured, for example, “1” for downlink subframes and “0” for uplink subframes, or verse vice.

In some embodiments, the length of the subframe bitmap may be equal to the length of the dwell period. In some embodiments, an anchor channel and a data channel may have different bitmap configurations.

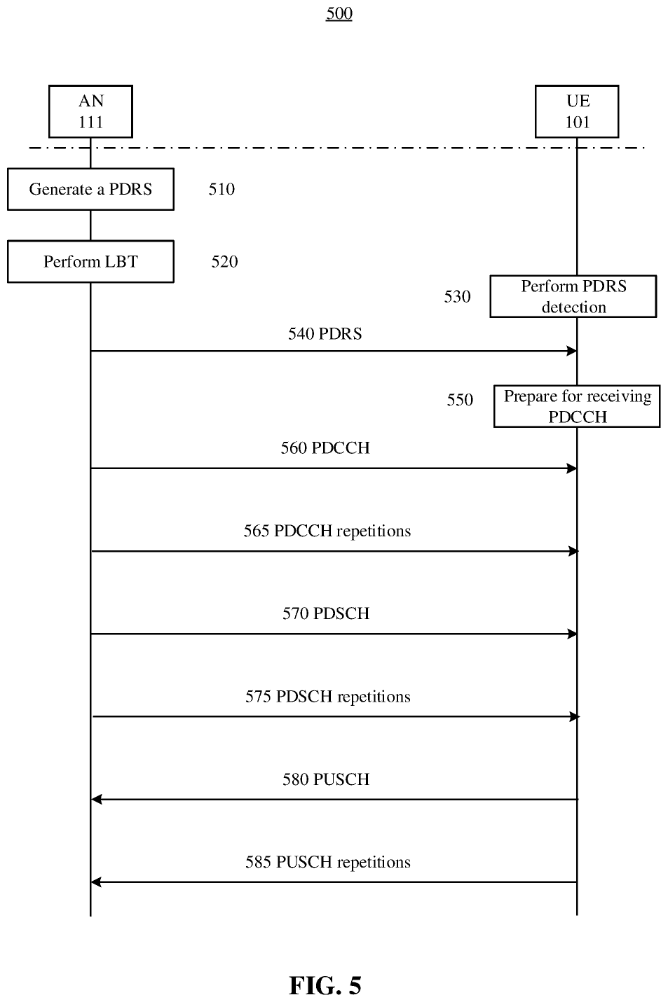

FIG. 5 is a flow chart showing operations on unlicensed spectrum based on LBT-based mechanism in accordance with some embodiments of the disclosure.

At 510, the AN 111 may generate a PDRS for transmission once a channel is available. At 520, the AN 111 may perform LBT to detect whether the channel is available.

For the UE 101, it may perform rounds of PDRS detection at 530. If the UE 101 has limitations in power, it may perform PDRS detection only at the beginning several subframes of the dwell period of the channel. In an embodiment, the number of the beginning subframes used for PDRS detection may be configured by the AN 111. In another embodiment, the UE 101 may report the number to the AN 111 through UE capacity reporting. If the UE 101 has no limitation in power, it may continue to perform PDRS detection until the PDRS is detected successfully.

At 540, the AN 111 may transmit the generated PDRS to the UE 101 if the channel is detected to be available. After receiving the PDSR, the UE 101 may prepare for receiving PDCCH at 550. In some embodiments, the UE 101 may determine a location of a starting subframe for the PDCCH based on detection of the PDRS.

In some embodiments, the location may be configured by the AN 111 with a predetermined number of relative subframes with respect to the subframe where the PDSR is detected. For example, the predetermined number may be 0, 2, 4, and the like. The embodiments of the present disclosure are not limited in this respect.

For example, if the predetermined number is configured to be 0, the UE 101 may be aware that the PDCCH will be transmitted by the AN 111 at a subframe immediately following the subframe where the PDRS is transmitted. In other words, if the number is configured to be 0, there are no additional subframes, that is, there are 0 subframes between the subframe for the PDSR and the starting subframe for the PDCCH.

As can be seen, the relative location of the starting subframe for the PDCCH with respect to the location of the subframe for the PDRS may be determined based on the predetermined number of relative subframes. However, as described in FIG. 3 above, the location of the starting subframe for the PDCCH within the dwell period of the channel is floating, as the AN 111 may perform multiple times of CCA and/or eCCA, which is not fixed.

In some embodiments, the starting subframe for the PDCCH may be determined based on an absolute subframe index. For example, for two times repetition, the starting subframe for the PDCCH may range from 0^{th}, 2^{th}, 4^{th} subframe, as in a legacy eMTC system.

In some embodiments, a starting OFDM symbol for the PDCCH is the first OFDM symbol within the starting subframe by default. In some embodiments, the starting OFDM symbol for the PDCCH may be configured by the AN 111 via high layer signaling.

In some embodiments, the AN 111 may transmit a demodulation reference signal (DMRS) corresponding to the PDCCH for decoding the PDCCH. One DMRS port may be configured for transmission of the DMRS if the PDCCH is provisioned with localized resource elements (REs). Two DMRS ports may be configured for transmission of the DMRS if the PDCCH is provisioned with distributed REs. In some embodiments, REs for cell reference signal (CRS) corresponding to the PDCCH may be reserved for quality measurement. In some embodiments, the REs for CRS may be used for transmission of the PDCCH, that is, no REs will be used for the CRS.

In some embodiments, CRS may be used for both of channel estimation and decoding the PDCCH. The PDCCH may be quasi co-located with one or more CRS ports that are used for transmission of the CRS. Association between the PDCCH and the one or more CRS ports may be configured by the AN 111 through high layer signaling. For beamforming on the PDCCH, precoding matrix indicator (PMI) and antenna port information of the PDCCH may be indicated by the AN 111 through high layer signaling.

At 560, the AN 111 may transmit the PDCCH to the UE 101. At 565, the AN 111 may transmit one or more repetitions of the PDCCH to the UE 101 to improve performance of decoding.

In some embodiments, the number of resource blocks (RBs) provisioned for the PDCCH may be predefined or indicated by the AN 111 via high layer signaling, for example, in the master information block (MIB) and/or system information block (SIB). Six or fewer RBs may be provisioned for the PDCCH, e.g., 1 RB, 3 RBs, and the like. The embodiments are not limited in this respect. In some embodiments, specific RB index for the PDCCH may be configured by the AN 111 via high layer signaling.

In some embodiments, the one or more repetitions of the PDCCH may be transmitted M subframes after the PDCCH, where M is a positive integer.

In some embodiments, the number of repetitions of the PDCCH may be selected from a set of {1,2,4,8,16,32,64,128,256} by the AN 111. In some embodiments, the number of repetitions of the PDCCH may be a subset of a common search space and a UE specific search space both of which are included for the PDCCH. The common search space and the UE specific search space are multiplexed in either time division multiplexing (TDM) or frequency division multiplexing (FDM).

In some embodiments, the one or more repetitions of the PDCCH are transmitted in the channel. The one or more repetitions of the PDCCH are received in contiguous subframes or non-contiguous subframes within the dwell period. The AN 111 may further transmit other repetitions of the PDCCH in another channel. In some embodiments, the UE 101 may drop the other repetitions of the PDCCH in the another channel.

In some embodiments, the one or more repetitions of the PDCCH are transmitted across more than one channels. If the number of repetitions is larger than a channel switching interval used, the repetitions may span across different hops. In some embodiments, the UE 101 may detect whether a new channel is acquired through the CRS or the PDRS before receiving the PDCCH on the new channel.

The UE 101 may combine the PDCCH and the one or more repetitions of the PDCCH to decode them jointly, such that performance in decoding may be improved. The UE 101 may perform blind detection with various downlink control information (DCI) format in a recursive way to determine the DCI for the PDCCH. The UE 101 may determine the number of subframes for the PDCCH based on the DCI.

In some embodiments, frequency hopping for the PDCCH within the same channel is disabled, as bandwidth of the system on unlicensed spectrum is narrow, e.g., 1.4 MHz.

At 570, the AN 111 may transmit a PDSCH associated with the PDCCH to the UE 101. At 575, the AN 111 may transmit one or more repetitions of the PDSCH to the UE 101.

Both of the PDCCH and the PDSCH may be transmitted in the downlink subframes. In some embodiments, they may be transmitted at each valid downlink subframe. In other words, the first subframe of the PDCCH may be the same as the first subframe of the PDSCH.

In some embodiments, the beginning several valid downlink subframes are utilized for the PDCCH, and the remaining valid downlink subframes are utilized for the PDSCH. In some embodiments, the PDSCH may be transmitted later than the ending subframe of the last one of the one or more repetition of the PDCCH by a number of subframes. The number may be predefined or configured by the AN 111 and it may be a positive integer. In particularly, the PDSCH may be transmitted in a subframe immediately following an ending subframe of the last one of the one or more repetition of the PDCCH.

In some embodiments, the PDCCH may be multiplexed with an un-associated PDSCH in the same subframe as well as respective repetitions, which is the same as a legacy MTC system. In some embodiments, the PDCCH may not be multiplexed with the un-associated or associated PDSCH in the same subframe for simplicity.

In some embodiments, the number of the repetitions of the PDSCH may be configured by the AN 111. The number of the repetitions of the PDSCH may be the same as that of the repetitions of the PDCCH. Alternatively, the number of the repetitions of the PDSCH may be different from that of the repetitions of the PDCCH.

In some embodiments, the one or more repetitions of the PDSCH are transmitted in the channel. The one or more repetitions of the PDSCH are received in contiguous subframes or non-contiguous subframes within the dwell period. The AN 111 may further transmit other repetitions of the PDSCH in another channel. In some embodiments, the UE 101 may drop the other repetitions of the PDSCH in the another channel.

In some embodiments, the one or more repetitions of the PDSCH are transmitted across more than one channels. Whether the repetitions of the PDSCH can be spanned to multiple channels may be configured by the AN 111.

At 580, the UE 101 may transmit a physical uplink share channel (PUSCH) associated with the PDCCH to the AN 111. At 585, the UE 101 may transmit one or more repetitions of the PUSCH to the AN 111.

In some embodiments, the AN 111 may configure a location of a starting subframe for the PUSCH, for transmission by the UE 101 W subframes after the reception of the PDCCH. W is a positive integer. In some embodiments, W may be configured by the AN 111 via the DCI.

In some embodiments, the starting subframe for the PUSCH may be derived based on an offset which is relevant to the ending of the corresponding PDCCH. In some embodiments, the starting subframe for the PUSCH may be derived based on an offset which is relevant to the ending of downlink subframe. In some embodiments, the offset may be indicated via the DCI.

In some embodiments, the AN 111 may configure location of subframes for the one or more repetitions of the PUSCH. The one or more repetitions of the PUSCH may be configured, for transmission in non-contiguous subframes. For example, 10 times repetition may span on subframes No. 40 to 44 and 50-54. There is an off period for PUSCH.

In some embodiments, the AN 111 may limit all repetitions of the PUSCH for transmission by the UE in the same channel as corresponding PDCCH. In some embodiments, the AN 111 may configure location of subframes for some repetitions of the PUSCH, for transmission by the UE in another channel. In some embodiments, the AN 111 may configure location of subframes for the PUSCH and its repetitions for transmission by the UE in a different channel from its corresponding PDCCH. Whether the PUSCH and/or its repetitions can be spanned to multiple channels may be configured by the AN 111.

In some embodiments, frequency hopping for the PDSCH or the PUSCH within the same channel may be supported. In some embodiments, it is disabled.

Sequence of the operations above is not limited to the illustration in the FIG. 5. For example, PUSCH may be transmitted prior to transmission of PDSCH. The embodiments are not limited in this respect.

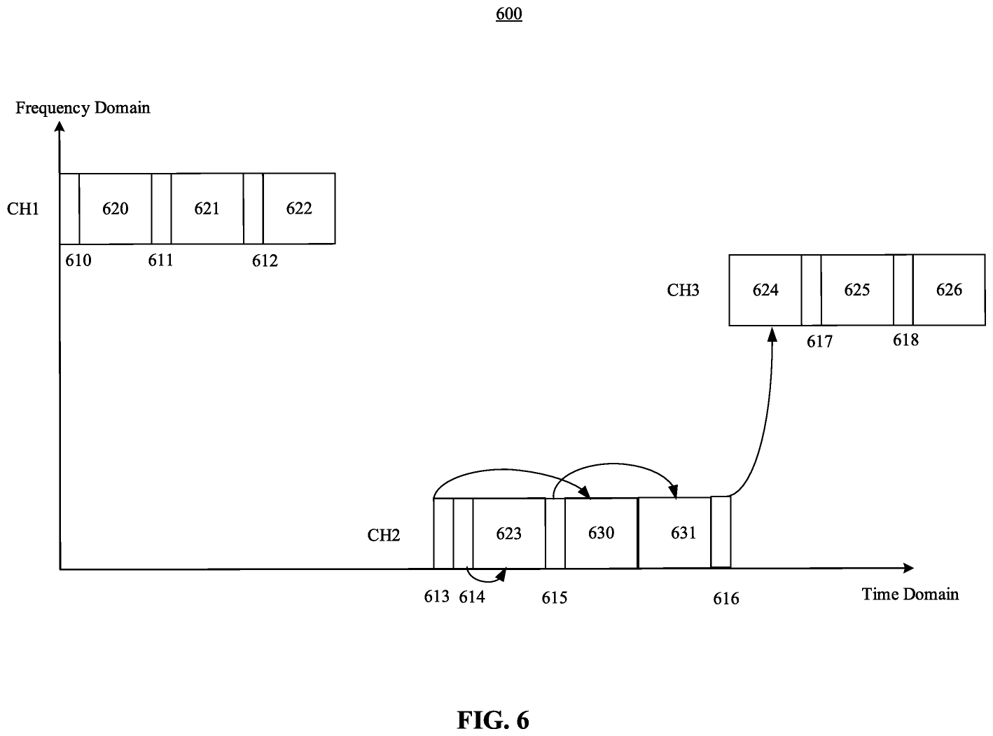

FIG. 6 shows an example scheduling 600 of PDCCH for PDSCH and PUSCH in accordance with some embodiments of the disclosure.

In FIG. 6, the PDCCH (610, 611,612, 613, 614, 615, 616, 617 and 618), PDSCH (620, 621, 622, 623, 624, 625 and 626) and PUSCH (630 and 631) may occupy the whole bandwidth. There are three channels shown in FIG. 6. In channel CH1, each PDCCH may schedule respective PDSCH. In some embodiments, the PDCCH 610 and the corresponding PDSCH 620 may be directed to a first UE; the PDCCH 611 and the corresponding PDSCH 621 may be directed to a second UE; and the PDCCH 612 and the corresponding PDSCH 622 may be directed to a third UE. In this context, the “PDCCH” may include repetitions of PDCCH, and the “PDSCH” may include repetitions of PDSCH.

In channel CH2, the PDCCH 613 may schedule the PUSCH 630. Between the PDCCH 613 and corresponding PUSCH 630, the PDCCH 614 and its corresponding PDSCH 623 as well as the PDCCH 615 are configured for transmission. The PUSCH 631 is scheduled by the PDCCH 615 after the PUSCH 630. At the end of the dwell period of the CH2, the PDCCH 616 is configured for transmission. Here, frequency hopping occurs from channel CH2 to channel CH3.

In channel CH3, the PUSCH 624 corresponding to the PDCCH 616 is scheduled. Then the PDCCH 617 may schedule the PDSCH 625, and the PDCCH 618 may schedule the PDSCH 626.

FIG. 6 only shows some examples of transmission of PDCCH, PDSCH and PUSCH. There may be some other scheduling ways, which have been described in combination with FIGS. 2 to 5.

The above description is mainly directed to an adaptive frequency hopping system. However, communication in LTE system on the unlicensed spectrum is not limited to the adaptive frequency hopping system, a non-adaptive frequency hopping system may also be operable on the unlicensed spectrum.

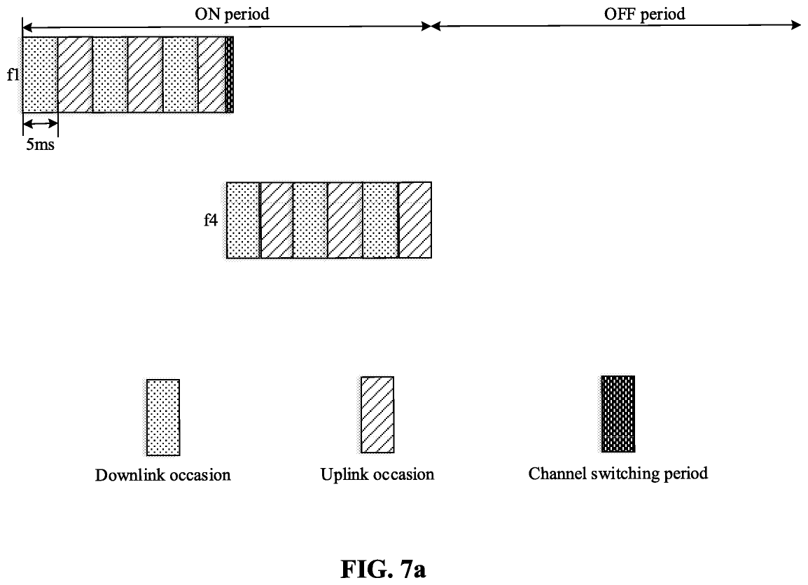

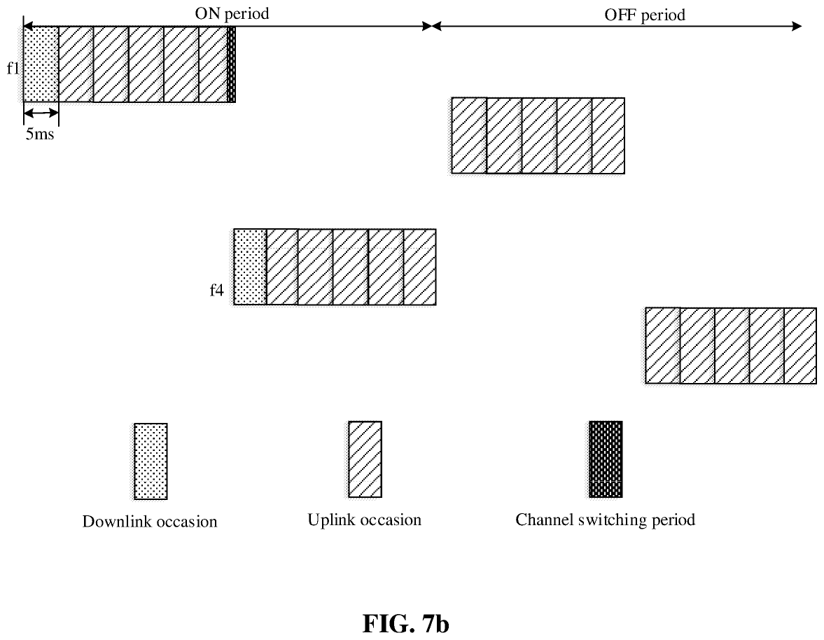

FIG. 7a shows an example of a non-adaptive frequency hopping in accordance with some embodiments of the disclosure. FIG. 7b shows another example of a non-adaptive frequency hopping in accordance with some embodiments of the disclosure.

In some embodiments, an ON period and an OFF period may be configured by an AN via high layer signaling, as shown in FIG. 7a and FIG. 7b. Here, each downlink occasion may include 5 valid downlink subframes, that is, 5 ms, as shown in FIG. 7a and FIG. 7b. The uplink occasion may include the same or different numbers of valid uplink subframes. Channel switching period is configured at the end of channel f1, as shown in FIG. 7a and FIG. 7b. However, the embodiments are not limited in this respect. Channel switching period may be configured at the beginning of a channel.

In FIG. 7a, downlink occasions and uplink occasions are configured during the ON period. The UE and the AN may keep silence to keep power during OFF period.

In FIG. 7b, downlink occasions and a portion of uplink occasions are configured during the ON period. During the OFF period, however, only uplink occasions may be configured to transmit. In some embodiments, as shown in FIG. 7b, one downlink occasion is followed by at least ten uplink occasions. These uplink occasions may be directed to the same UE and/or different UEs.

For a non-adaptive frequency hopping system, in some embodiments, the PDSCH may be repeated at, for example, subframe 10 to 14, keep silent for 5 subframes, and continue to transmit on the following five subframes.

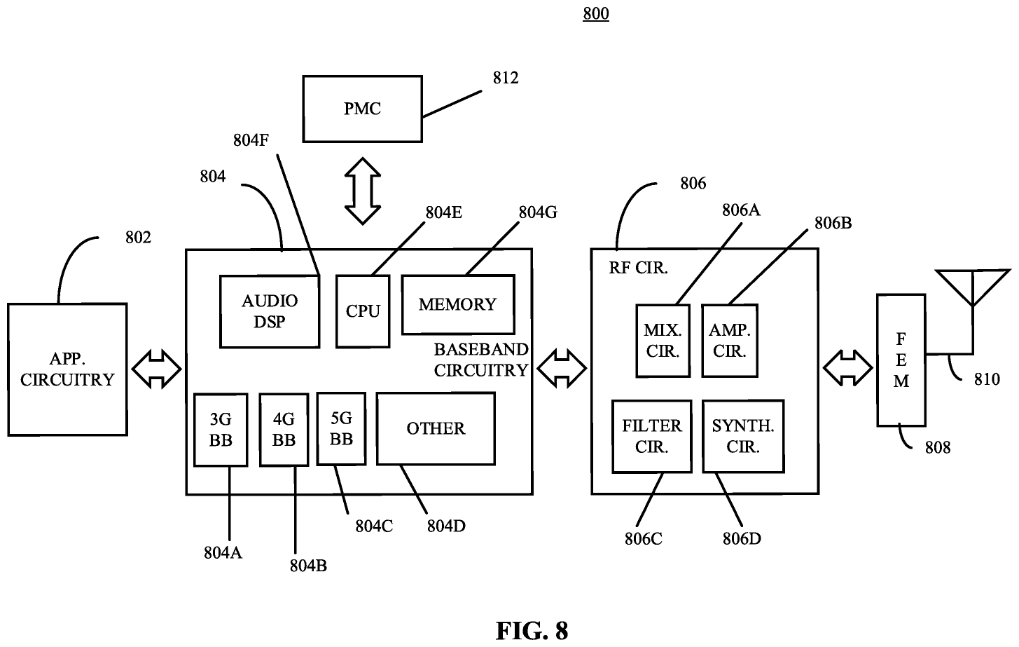

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or an AN. In some embodiments, the device 800 may include less elements (e.g., an AN may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer. As referred to herein, Layer 2 may comprise a medium access control (MAC) layer, a radio link control (RLC) layer, and a packet data convergence protocol (PDCP) layer. As referred to herein, Layer 1 may comprise a physical (PHY) layer of a UE/RAN node.

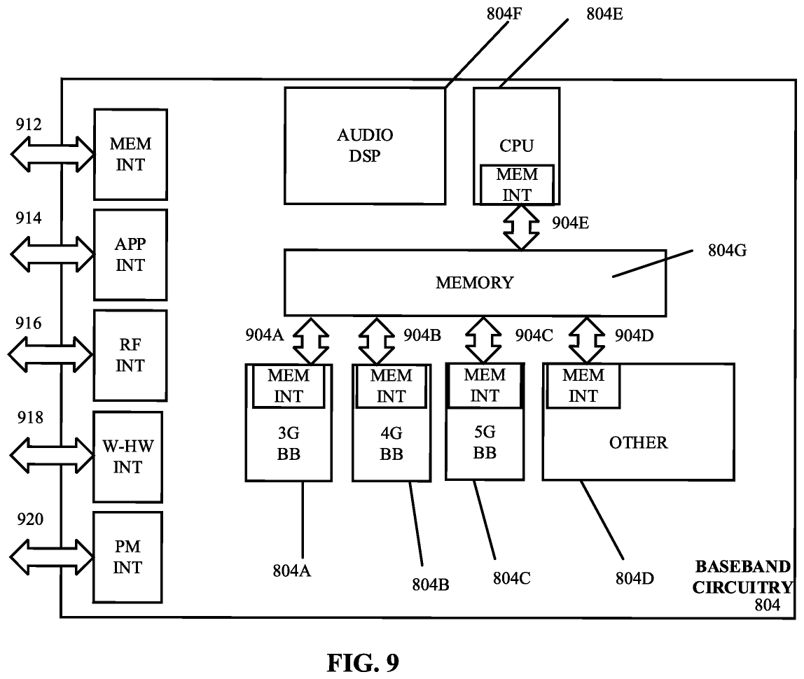

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

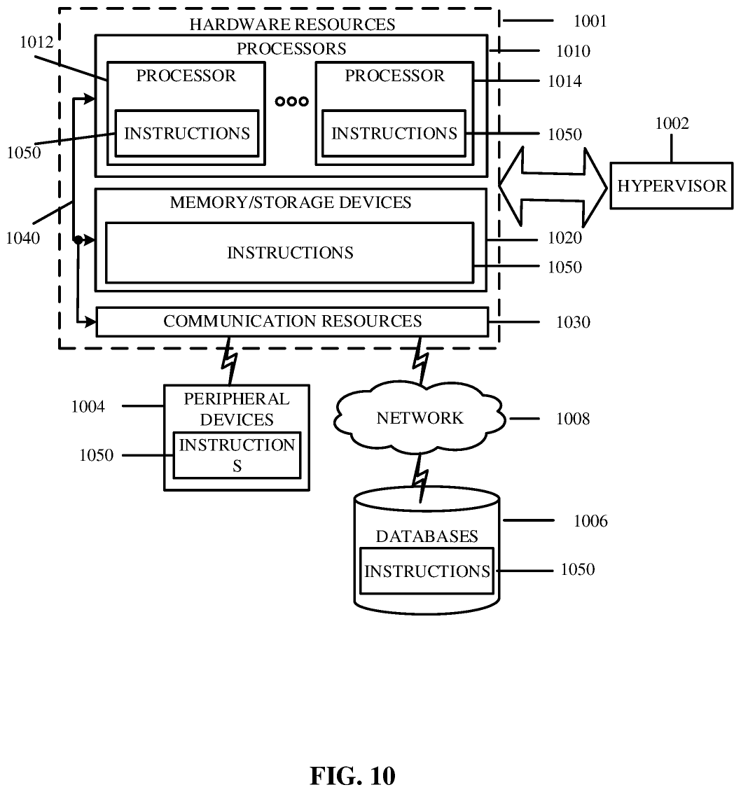

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

The following paragraphs describe examples of various embodiments.

Example 1 include an apparatus for a user equipment (UE), including circuitry configured to: detect a presence detection reference signal for a channel having a dwell period on an unlicensed spectrum; and determine a location of a starting subframe for a physical downlink control channel (PDCCH) in the dwell period based on detection of the presence detection reference signal; and a memory to store the location of the starting subframe.

Example 2 includes the apparatus of Example 1, wherein the location of the starting subframe for the PDCCH is floating.

Example 3 includes the apparatus of Example 1 or 2, wherein the location of the starting subframe for the PDCCH is N subframes after the presence detection reference signal, wherein N is a positive integer.

Example 4 includes the apparatus of any of Examples 1 to 3, wherein the circuitry is configured to: decode the PDCCH and one or more repetitions of the PDCCH, wherein the PDCCH is received at the location and the one or more repetitions of the PDCCH are received M subframes after the PDCCH, wherein M is a positive integer.

Example 5 includes the apparatus of Example 4, wherein the one or more repetitions of the PDCCH are received in the channel.

Example 6 includes the apparatus of Example 5, wherein the one or more repetitions of the PDCCH are received in contiguous subframes or non-contiguous subframes.

Example 7 includes the apparatus of Example 4, wherein the circuitry is configured to: drop repetitions of the PDCCH that are in another channel.

Example 8 includes the apparatus of any of Examples 1 to 7, wherein a starting Orthogonal Frequency Division Multiplexing (OFDM) symbol for the PDCCH is the first OFDM symbol within the starting subframe.

Example 9 includes the apparatus of any of Examples 1 to 8, wherein the PDCCH includes a common search space and a UE specific search space.

Example 10 includes the apparatus of Example 9, wherein the common search space and the UE specific search space are multiplexed in either time division multiplexing (TDM) or frequency division multiplexing (FDM).

Example 11 includes the apparatus of any of Examples 1 to 10, wherein the PDCCH has resource blocks the number of which is predefined or indicated by an access node via high layer signaling.

Example 12 includes the apparatus of Example 11, wherein the number of the resource blocks is less than or equal to 6.

Example 13 includes the apparatus of any of Examples 1 to 12, wherein the circuitry is configured to: disable frequency hopping for the PDCCH within the channel.

Example 14 includes the apparatus of any of Examples 1 to 13, wherein the circuitry is configured to: demodulate a demodulation reference signal (DMRS) corresponding to the PDCCH for decoding the PDCCH.

Example 15 includes the apparatus of any of Examples 1 to 14, wherein the circuitry is configured to: demodulate cell reference signal (CRS) corresponding to the PDCCH for quality measurement of the channel.

Example 16 includes the apparatus of any of Examples 4 to 15, wherein the circuitry is configured to: decode a physical downlink share channel (PDSCH) associated with the PDCCH, wherein the PDSCH is received in a subframe immediately following an ending subframe of a last one of the one or more repetition of the PDCCH.

Example 17 includes the apparatus of Example 16, wherein the circuitry is configured to: disable frequency hopping for the PDSCH within the channel.

Example 18 includes the apparatus of Example 16 or 17, wherein the circuitry is configured to: decode one or more repetitions of the PDSCH, wherein the one or more repetitions of the PDSCH is received in the channel.

Example 19 includes the apparatus of Example 18, wherein the number of the one or more repetitions of the PDSCH is configured by an access node.

Example 20 includes the apparatus of Example 19, wherein the one or more repetitions of the PDSCH are received in contiguous subframes or non-contiguous subframes.

Example 21 includes the apparatus of Example 18, wherein the circuitry is configured to: drop repetitions of the PDSCH that are in another channel.

Example 22 includes the apparatus of Example 4, wherein the circuitry is configured to: encode a physical uplink share channel (PUSCH) associated with the PDCCH, wherein the PUSCH is transmitted W subframes after reception of the PDCCH, wherein W is a positive integer.

Example 23 includes the apparatus of Example 22, wherein W is configured via downlink channel information (DCI).

Example 24 includes the apparatus of Example 22, wherein the circuitry is configured to: encode the PUSCH, for transmission in unit of a predefined number of contiguous subframes.

Example 25 includes the apparatus of Example 24, wherein the predefined number is 5.

Example 26 includes the apparatus of Example 22, wherein the circuitry is configured to: disable frequency hopping for the PUSCH within the channel.

Example 27 includes the apparatus of Example 22, wherein the circuitry is configured to: encode one or more repetitions of the PUSCH, wherein the one or more repetitions of the PUSCH are transmitted in non-contiguous subframes.

Example 28 includes the apparatus of Example 22, wherein the circuitry is configured to: encode one or more repetitions of the PUSCH for transmission in another channel.

Example 29 includes the apparatus of any of Examples 1 to 28, wherein the dwell period is fixed.

Example 30 includes the apparatus of Example 29, wherein the dwell period includes a fixed downlink dwell period and a fixed uplink dwell period.

Example 31 includes the apparatus of any of Examples 1 to 30, wherein the circuitry is configured to: decode a number of subframes for the detection of the presence detection reference signal, wherein the number is configured by an access node.

Example 32 includes an apparatus for an access node, including circuitry configured to: perform listen before talk (LBT) procedure for a channel having a dwell period on an unlicensed spectrum to detect whether the channel is available; generate a presence detection reference signal, for transmission when the channel is detected to be available; and configure a location of a starting subframe for a physical downlink control channel (PDCCH) in the dwell period based on the transmission of the presence detection reference signal; and a memory to store the location of the starting subframe.

Example 33 includes the apparatus of Example 32, wherein the location of the starting subframe for the PDCCH is floating.

Example 34 includes the apparatus of Example 32 or 33, wherein the circuitry is configured to: configure the starting subframe for the PDCCH, for transmission N subframes after the presence detection reference signal, wherein N is a positive integer.

Example 35 includes the apparatus of any of Examples 32 to 34, wherein the circuitry is configured to: encode the PDCCH and one or more repetitions of the PDCCH; and configure the PDCCH for transmission at the location and configure the one or more repetitions of the PDCCH, for transmission M subframes after the PDCCH, wherein M is a positive integer.

Example 36 includes the apparatus of Example 35, wherein the circuitry is configured to: configure the one or more repetitions of the PDCCH, for transmission in the channel.

Example 37 includes the apparatus of Example 36, wherein the circuitry is configured to: configure the one or more repetitions of the PDCCH, for transmission in contiguous subframes or non-contiguous subframes.

Example 38 includes the apparatus of any of Examples 32 to 37, wherein the circuitry is configured to: configure a starting Orthogonal Frequency Division Multiplexing (OFDM) symbol for the PDCCH to be the first OFDM symbol within the starting subframe.

Example 39 includes the apparatus of any of Examples 32 to 39, wherein the PDCCH includes a common search space and a UE specific search space.

Example 40 includes the apparatus of Example 39, wherein the circuitry is configured to: multiplex the common search space and the UE specific search space in either time division multiplexing (TDM) or frequency division multiplexing (FDM).

Example 41 includes the apparatus of any of Examples 32 to 40, wherein the circuitry is configured to: configure a number of resource blocks for the PDCCH via high layer signaling.

Example 42 includes the apparatus of Example 41, wherein the number of the resource blocks is less than or equal to 6.

Example 43 includes the apparatus of any of Examples 32 to 42, wherein the circuitry is configured to: disable frequency hopping for the PDCCH within the channel.

Example 44 includes the apparatus of any of Examples 32 to 43, wherein the circuitry is configured to: modulate demodulation reference signal (DMRS) corresponding to the PDCCH.

Example 45 includes the apparatus of any of Examples 32 to 44, wherein the circuitry is configured to: modulate cell reference signal (CRS) corresponding to the PDCCH for quality measurement of the channel by a user equipment (UE).

Example 46 includes the apparatus of any of Examples 35 to 45, wherein the circuitry is configured to: encode a physical downlink share channel (PDSCH) associated with the PDCCH; and configure the PDSCH, for transmission in a subframe immediately following an ending subframe of a last one of the one or more repetition of the PDCCH.

Example 47 includes the apparatus of Example 46, wherein the circuitry is configured to: disable frequency hopping for the PDSCH within the channel.

Example 48 includes the apparatus of Example 46, wherein the circuitry is configured to: configure one or more repetitions of the PDSCH, for transmission in the channel.

Example 49 includes the apparatus of Example 48, wherein the circuitry is configured to: configure the one or more repetitions of the PDSCH, for transmission in contiguous subframes or non-contiguous subframes.

Example 50 includes the apparatus of any of Examples 32 to 49, wherein the circuitry is configured to: configure a location of a starting subframe for a physical uplink share channel (PUSCH) associated with the PDCCH, for transmission by a user equipment (UE) W subframes after reception of the PDCCH, wherein W is a positive integer.

Example 51 includes the apparatus of Example 50, wherein the circuitry is configured to: configure the W via downlink channel information (DCI).

Example 52 includes the apparatus of Example 50, wherein the circuitry is configured to: disable frequency hopping for the PUSCH within the channel.

Example 53 includes the apparatus of Example 50, wherein the circuitry is configured to: configure location of subframes for one or more repetitions of the PUSCH, for transmission in non-contiguous subframes by the UE.

Example 54 includes the apparatus of Example 50, wherein the circuitry is configured to: configure location of subframes for one or more repetitions of the PUSCH, for transmission in another channel by the UE.

Example 55 includes the apparatus of any of Examples 32 to 54, wherein the dwell period is fixed.

Example 56 includes the apparatus of Example 55, wherein the dwell period includes a fixed downlink dwell period and a fixed uplink dwell period.

Example 57 includes the apparatus of Example 50, wherein the circuitry is configured to: decode the PUSCH that is transmitted in unit of a predefined number of contiguous subframes.

Example 58 includes the apparatus of Example 57, wherein the predefined number is 5.

Example 59 includes the apparatus of any of Examples 32 to 58, wherein the circuitry is configured to: configure a number of subframes for detection of the presence detection reference signal by a user equipment (UE).

Example 60 includes the apparatus of any of Examples 32 to 59, wherein the circuitry is configured to: perform channel switching from the channel to another channel at a first subframe temporally of dwell period of the another channel.

Example 61 includes the apparatus of Example 60, wherein the circuitry is configured to: perform the channel switching at first two Orthogonal Frequency Division Multiplexing (OFDM) symbols temporally of the first subframe.

Example 62 includes a method performed by a user equipment (UE), including: detecting a presence detection reference signal for a channel having a dwell period on an unlicensed spectrum; and determining a location of a starting subframe for a physical downlink control channel (PDCCH) in the dwell period based on detection of the presence detection reference signal.

Example 63 includes the method of Example 62, wherein the location of the starting subframe for the PDCCH is floating.

Example 64 includes the method of Example 62 or 63, wherein the location of the starting subframe for the PDCCH is N subframes after the presence detection reference signal, wherein N is a positive integer.

Example 65 includes the method of any of Examples 62 to 64, wherein the method further includes: decoding the PDCCH and one or more repetitions of the PDCCH, wherein the PDCCH is received at the location and the one or more repetitions of the PDCCH are received M subframes after the PDCCH, wherein M is a positive integer.

Example 66 includes the method of Example 65, wherein the one or more repetitions of the PDCCH are received in the channel.

Example 67 includes the method of Example 66, wherein the one or more repetitions of the PDCCH are received in contiguous subframes or non-contiguous subframes.

Example 68 includes the method of Example 65, wherein the method further includes: dropping repetitions of the PDCCH that are in another channel.

Example 69 includes the method of any of Examples 62 to 68, wherein a starting Orthogonal Frequency Division Multiplexing (OFDM) symbol for the PDCCH is the first OFDM symbol within the starting subframe.

Example 70 includes the method of any of Examples 62 to 69, wherein the PDCCH includes a common search space and a UE specific search space.

Example 71 includes the method of Example 70, wherein the common search space and the UE specific search space are multiplexed in either time division multiplexing (TDM) or frequency division multiplexing (FDM).

Example 72 includes the method of any of Examples 62 to 71, wherein the PDCCH has resource blocks the number of which is predefined or indicated by an access node via high layer signaling.

Example 73 includes the method of Example 72, wherein the number of the resource blocks is less than or equal to 6.

Example 74 includes the method of any of Examples 62 to 73, wherein the method further includes: disabling frequency hopping for the PDCCH within the channel.

Example 75 includes the method of any of Examples 62 to 74, wherein the method further includes: demodulating a demodulation reference signal (DMRS) corresponding to the PDCCH for decoding the PDCCH.

Example 76 includes the method of any of Examples 62 to 76, wherein the method further includes: demodulating cell reference signal (CRS) corresponding to the PDCCH for quality measurement of the channel.

Example 77 includes the method of any of Examples 65 to 76, wherein the method further includes: decoding a physical downlink share channel (PDSCH) associated with the PDCCH, wherein the PDSCH is received in a subframe immediately following an ending subframe of a last one of the one or more repetition of the PDCCH.

Example 78 includes the method of Example 77, wherein the method further includes: disabling frequency hopping for the PDSCH within the channel.

Example 79 includes the method of Example 77 or 78, wherein the method further includes: decoding one or more repetitions of the PDSCH, wherein the one or more repetitions of the PDSCH is received in the channel.

Example 80 includes the method of Example 79, wherein the number of the one or more repetitions of the PDSCH is configured by an access node.

Example 81 includes the method of Example 80, wherein the one or more repetitions of the PDSCH are received in contiguous subframes or non-contiguous subframes.

Example 82 includes the method of Example 80, wherein the method further includes: dropping repetitions of the PDSCH that are in another channel.

Example 83 includes the method of Example 65, wherein the method further includes: encoding a physical uplink share channel (PUSCH) associated with the PDCCH, wherein the PUSCH is transmitted W subframes after reception of the PDCCH, wherein W is a positive integer.

Example 84 includes the method of Example 83, wherein W is configured via downlink channel information (DCI).

Example 85 includes the method of Example 83, wherein encoding a physical uplink share channel (PUSCH) associated with the PDCCH includes: encoding the PUSCH, for transmission in unit of a predefined number of contiguous subframes.

Example 86 includes the method of Example 85, wherein the predefined number is 5.

Example 87 includes the method of Example 83, wherein the method further includes: disabling frequency hopping for the PUSCH within the channel.

Example 88 includes the method of Example 83, wherein the method further includes: encoding one or more repetitions of the PUSCH, wherein the one or more repetitions of the PUSCH are transmitted in non-contiguous subframes.

Example 89 includes the method of Example 83, wherein the method further includes: encoding one or more repetitions of the PUSCH for transmission in another channel.

Example 90 includes the method of any of Examples 62 to 89, wherein the dwell period is fixed.

Example 91 includes the method of Example 90, wherein the dwell period includes a fixed downlink dwell period and a fixed uplink dwell period.

Example 92 includes the method of any of Examples 62 to 91, wherein the method further includes: decoding a number of subframes for the detection of the presence detection reference signal, wherein the number is configured by an access node.

Example 93 includes a method performed by an access node, including: performing listen before talk (LBT) procedure for a channel having a dwell period on an unlicensed spectrum to detect whether the channel is available; generating a presence detection reference signal, for transmission when the channel is detected to be available; and configuring a location of a starting subframe for a physical downlink control channel (PDCCH) in the dwell period based on the transmission of the presence detection reference signal.

Example 94 includes the method of Example 93, wherein the location of the starting subframe for the PDCCH is floating.

Example 95 includes the method of Example 93 or 94, wherein the method further includes: configuring the starting subframe for the PDCCH, for transmission N subframes after the presence detection reference signal, wherein N is a positive integer.

Example 96 includes the method of any of Examples 93 to 95, wherein the method further includes: encoding the PDCCH and one or more repetitions of the PDCCH; and configuring the PDCCH for transmission at the location and configure the one or more repetitions of the PDCCH, for transmission M subframes after the PDCCH, wherein M is a positive integer.

Example 97 includes the method of Example 96, wherein the method further includes: configuring the one or more repetitions of the PDCCH, for transmission in the channel.

Example 98 includes the method of Example 97, wherein the method further includes: configuring the one or more repetitions of the PDCCH, for transmission in contiguous subframes or non-contiguous subframes.

Example 99 includes the method of any of Examples 93 to 98, wherein the method further includes: configuring a starting Orthogonal Frequency Division Multiplexing (OFDM) symbol for the PDCCH to be the first OFDM symbol within the starting subframe.

Example 100 includes the method of any of Examples 93 to 99, wherein the PDCCH includes a common search space and a UE specific search space.

Example 101 includes the method of Example 100, wherein the method further includes: multiplexing the common search space and the UE specific search space in either time division multiplexing (TDM) or frequency division multiplexing (FDM).

Example 102 includes the method of any of Examples 93 to 101, wherein the method further includes: configuring a number of resource blocks for the PDCCH via high layer signaling.

Example 103 includes the method of Example 102, wherein the number of the resource blocks is less than or equal to 6.

Example 104 includes the method of any of Examples 93 to 103, wherein the method further includes: disabling frequency hopping for the PDCCH within the channel.

Example 105 includes the method of any of Examples 93 to 104, wherein the method further includes: modulating demodulation reference signal (DMRS) corresponding to the PDCCH.

Example 106 includes the method of any of Examples 93 to 105, wherein the method further includes: modulating cell reference signal (CRS) corresponding to the PDCCH for quality measurement of the channel by a user equipment (UE).

Example 107 includes the method of any of Examples 96 to 106, wherein the method further includes: encoding a physical downlink share channel (PDSCH) associated with the PDCCH; and configuring the PDSCH, for transmission in a subframe immediately following an ending subframe of a last one of the one or more repetition of the PDCCH.

Example 108 includes the method of Example 107, wherein the method further includes: disabling frequency hopping for the PDSCH within the channel.

Example 109 includes the method of Example 107, wherein the method further includes: configuring one or more repetitions of the PDSCH, for transmission in the channel.

Example 110 includes the method of Example 109, wherein the method further includes: configuring the one or more repetitions of the PDSCH, for transmission in contiguous subframes or non-contiguous subframes.

Example 111 includes the method of any of Examples 93 to 110, wherein the method further includes: configuring a location of a starting subframe for a physical uplink share channel (PUSCH) associated with the PDCCH, for transmission by a user equipment (UE) W subframes after reception of the PDCCH, wherein W is a positive integer.

Example 112 includes the method of Example 111, wherein the method further includes: configuring the W via downlink channel information (DCI).

Example 113 includes the method of Example 111, wherein the method further includes: disabling frequency hopping for the PUSCH within the channel.

Example 114 includes the method of Example 111, wherein the method further includes: configuring location of subframes for one or more repetitions of the PUSCH, for transmission in non-contiguous subframes by the UE.

Example 115 includes the method of Example 111, wherein the method further includes: configuring location of subframes for one or more repetitions of the PUSCH, for transmission in another channel by the UE.

Example 116 includes the method of any of Examples 93 to 115, wherein the dwell period is fixed.

Example 117 includes the method of Example 116, wherein the dwell period includes a fixed downlink dwell period and a fixed uplink dwell period.

Example 118 includes the method of any of Examples 93 to 117, wherein the method further includes: decoding the PUSCH that is transmitted in unit of a predefined number of contiguous subframes.

Example 119 includes the method of Example 118, wherein the predefined number is 5.

Example 120 includes the method of any of Examples 93 to 119, wherein the method further includes: configuring a number of subframes for detection of the presence detection reference signal by a user equipment (UE).

Example 121 includes the method of any of Examples 93 to 120, wherein the method further includes: performing channel switching from the channel to another channel at a first subframe temporally of dwell period of the another channel.

Example 122 includes the method of Example 121, wherein the method further includes: performing the channel switching at first two Orthogonal Frequency Division Multiplexing (OFDM) symbols temporally of the first subframe.

Example 123 includes a non-transitory computer-readable medium having instructions stored thereon, the instructions when executed by one or more processor(s) causing the processor(s) to perform the method of any of Examples 62 to 92.

Example 124 includes a non-transitory computer-readable medium having instructions stored thereon, the instructions when executed by one or more processor(s) causing the processor(s) to perform the method of any of Examples 93 to 122.

Example 125 includes an apparatus for user equipment (UE), including means for performing the actions of the method of any of Examples 62 to 92.

Example 126 includes an apparatus for an access node (AN), including means for performing the actions of the method of any of Examples 93 to 122.

Example 127 includes user equipment (UE) as shown and described in the description.

Example 128 includes an access node (AN) as shown and described in the description.

Example 129 includes a method performed at user equipment (UE) as shown and described in the description.

Example 130 includes a method performed at an access node (AN) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1.-25. (canceled)

26. An apparatus for a user equipment (UE), comprising:
circuitry to:
detect a presence detection reference signal for a channel having a dwell period on an unlicensed spectrum; and
determine a location of a starting subframe for a physical downlink control channel (PDCCH) in the dwell period based on detection of the presence detection reference signal; and
a memory to store the location of the starting subframe.

27. The apparatus of claim 26, wherein the location of the starting subframe for the PDCCH is floating.

28. The apparatus of claim 26, wherein the location of the starting subframe for the PDCCH is N subframes after the presence detection reference signal, wherein N is a positive integer.

29. The apparatus of claim 26, wherein the circuitry is to:
decode the PDCCH and one or more repetitions of the PDCCH, wherein the PDCCH is received at the location and the one or more repetitions of the PDCCH are received M subframes after the PDCCH, wherein M is a positive integer.

30. The apparatus of claim 29, wherein the circuitry is to:
drop repetitions of the PDCCH that are in another channel.

31. The apparatus of claim 26, wherein a starting Orthogonal Frequency Division Multiplexing (OFDM) symbol for the PDCCH is the first OFDM symbol within the starting subframe.

32. The apparatus of claim 26, wherein the circuitry is to:
disable frequency hopping for the PDCCH within the channel.

33. The apparatus of claim 29, wherein the circuitry is to:
decode a physical downlink share channel (PDSCH) associated with the PDCCH, wherein the PDSCH is received in a subframe immediately following an ending subframe of a last one of the one or more repetition of the PDCCH.

34. The apparatus of claim 33, wherein the circuitry is to:
disable frequency hopping for the PDSCH within the channel.

35. The apparatus of claim 33, wherein the circuitry is to:
decode one or more repetitions of the PDSCH, wherein the one or more repetitions of the PDSCH is received in the channel.

36. The apparatus of claim 35, wherein the number of the one or more repetitions of the PDSCH is configured by an access node.

37. The apparatus of claim 36, wherein the one or more repetitions of the PDSCH are received in contiguous subframes or non-contiguous subframes.

38. The apparatus of claim 35, wherein the circuitry is to:
drop repetitions of the PDSCH that are in another channel.

39. An apparatus for an access node, comprising:
circuitry to:
perform listen before talk (LBT) procedure for a channel having a dwell period on an unlicensed spectrum to detect whether the channel is available;
generate a presence detection reference signal, for transmission when the channel is detected to be available; and
configure a location of a starting subframe for a physical downlink control channel (PDCCH) in the dwell period based on the transmission of the presence detection reference signal; and
a memory to store the location of the starting subframe.

40. The apparatus of claim 39, wherein the circuitry is to:
configure a location of a starting subframe for a physical uplink share channel (PUSCH) associated with the PDCCH, for transmission by a user equipment (UE) W subframes after reception of the PDCCH, wherein W is a positive integer.

41. The apparatus of claim 40, wherein the circuitry is to:
configure the W via downlink channel information (DCI).

42. The apparatus of claim 40, wherein the circuitry is to:
disable frequency hopping for the PUSCH within the channel.

43. The apparatus of claim 40, wherein the circuitry is to:
configure location of subframes for one or more repetitions of the PUSCH, for transmission in non-contiguous subframes by the UE.

44. The apparatus of claim 40, wherein the circuitry is to:
configure location of subframes for one or more repetitions of the PUSCH, for transmission in another channel by the UE.

45. The apparatus of claim 39, wherein the dwell period is fixed.

46. The apparatus of claim 45, wherein the dwell period comprises a fixed downlink dwell period and a fixed uplink dwell period.

47. The apparatus of claim 40, wherein the circuitry is to:
decode the PUSCH that is transmitted in unit of a predefined number of contiguous subframes.

48. The apparatus of claim 47, wherein the predefined number is 5.

49. The apparatus of claim 39, wherein the circuitry is to:
perform channel switching from the channel to another channel at a first subframe temporally of dwell period of the another channel.

50. The apparatus of claim 49, wherein the circuitry is to:
perform the channel switching at first two Orthogonal Frequency Division Multiplexing (OFDM) symbols temporally of the first subframe.
